(19) United States
(12) Patent Application Publication
(10) Pub. No.: US 2018/0038316 A1
(43) Pub. Date: Feb. 8, 2018

(54) LIQUID-FUELED ROCKET ENGINE ASSEMBLIES, AND RELATED METHODS OF USING LIQUID-FUELED ROCKET ENGINE ASSEMBLIES

(71) Applicant: Orbital ATK, Inc., Plymouth, MN (US)

(72) Inventor: Vladimir V. Balepin, Manorville, NY (US)

(21) Appl. No.: 15/226,765

(22) Filed: Aug. 2, 2016

(51) Int. Cl. F02K 9/64; F02K 9/52; F02K 9/58; F02K 9/46

(52) U.S. Cl. CPC F02K 9/64; F02K 9/46; F02K 9/52; F02K 9/58

(57) ABSTRACT

A liquid-fueled rocket engine assembly comprises a combustor assembly, a combustor jacket for cooling the combustor assembly using pressurized liquid fuel exiting a fuel pump, a turbine for expanding gaseous fuel exiting the combustor jacket to power the fuel pump and/or an oxidizer pump, a flow control device for directing expanded gaseous fuel exiting the turbine through a first outlet and/or a second outlet, a discharge device for exhausting the expanded gaseous fuel exiting the first outlet, a heat exchanger for cooling the expanded gaseous fuel exiting the second outlet with some of the pressurized liquid fuel exiting the fuel pump, and a mixer for combining cooled fuel exiting the heat exchanger with liquid fuel to form mixed liquid fuel to be directed into the fuel pump. Another liquid-fueled rocket engine assembly and related methods are also described.

### TECHNICAL FIELD

Embodiments of the disclosure relate generally to liquid-fueled rocket engines assemblies, and to methods of using liquid-fueled rocket engine assemblies. More particularly, embodiments of the disclosure relate to liquid-fueled rocket engine assemblies including expander cycle configurations, and to methods of using such liquid-fueled rocket engine assemblies.

### BACKGROUND

Liquid-fueled rocket engine assemblies utilize liquids as one or more of propellant sources, fuel sources, and oxidizer sources. Liquid-fueled rocket engine assemblies can be quickly fueled and refueled, and the relatively high density of liquids can facilitate the use of relatively smaller storage vessels.

One example, of a liquid-fueled rocket engine assembly is an expander cycle rocket engine assembly. An expander cycle rocket engine assembly heats liquid fuel to form a gaseous fuel that is utilized to drive a turbine to power one or more pumps of the expander cycle rocket engine assembly. Expander cycle rocket engine assemblies do not require a gas generator or pre-burner. Some expander cycle rocket engine assemblies have a closed-cycle configuration wherein all of the gaseous fuel exiting the turbine is directed into a combustion chamber of the rocket engine assembly. However, such a configuration generally requires a relatively high pump discharge to combustion chamber pressure ratio between 2.5 and 3 or higher, which necessitates relatively high turbine power and turbine inlet pressure and can result in higher assembly weight and lower reliability. Other expander cycle rocket engine assemblies have an open-cycle configuration wherein a portion of the liquid fuel is heated and used to drive a turbine and is then discharged (i.e., is not directed into a combustion chamber of the rocket engine assembly). Such a configuration can reduce cycle peak pressures as compared to the previously mentioned closed-cycle configuration, but discharging some of the liquid fuel results in efficiency losses. Further expander cycle rocket engine assemblies exhibit a closed-cycle configuration wherein all of the gaseous fuel exiting the turbine is cooled, condensed, and mixed with additional liquid fuel. Such a configuration exhibits the high performance of the previously mentioned closed-cycle configuration and the reduced cycle peak pressure of the previously mentioned open-cycle configuration, but requires additional equipment (e.g., heat exchangers, condensers, mixers, etc.) that can be prohibitively large and heavy to facilitate various operational parameters (e.g., higher combustion chamber pressures, higher fluid flow rates, higher turbine power outputs, etc.) desirable or necessary for various applications of the expander rocket engine assemblies. In addition, such a configuration may be unable to support relatively higher chamber pressures when recirculation flow is unable to the fully condensed.

It would, therefore, be desirable to have new liquid-fueled rocket engine assemblies and related methods that alleviate one or more of the above problems.

### BRIEF SUMMARY

Embodiments described herein include liquid-fueled rocket engines assemblies, and methods of using the liquid-fueled rocket engine assemblies. In some embodiments, a liquid-fueled rocket engine assembly comprises a combustor assembly, a combustor jacket, a turbine, a flow control device, a discharge device, a heat exchanger, and a mixer. The combustor assembly comprises an injector, a combustion chamber, and a nozzle. The combustor jacket at least partially surrounds and is configured to cool the combustion chamber and the primary nozzle of the combustor assembly using a portion of a pressurized liquid fuel exiting a fuel pump. The turbine is configured and positioned to receive and expand a gaseous fuel exiting the combustor jacket to power one or more of the fuel pump and an oxidizer pump. The flow control device comprises a first outlet and a second outlet, and is configured and positioned to direct an expanded gaseous fuel exiting the turbine through one or more of the first outlet and the second outlet. The discharge device is configured and positioned to receive, expand, and exhaust at least a portion of the expanded gaseous fuel exiting the first outlet of the flow control device. The heat exchanger is configured and positioned to heat another portion of the pressurized liquid fuel exiting the fuel pump with at least a portion of the expanded gaseous fuel exiting the second outlet of the flow control device and to direct a resulting heated, pressurized liquid fuel into the combustor assembly. The mixer is configured and positioned to combine a cooled fuel exiting the heat exchanger with a liquid fuel exiting a fuel source to form a mixed liquid fuel and to direct the mixed liquid fuel to the fuel pump.

In additional embodiments, a liquid-fueled rocket engine assembly comprises an oxidizer pump, a fuel pump, a coolant pump, a combustor assembly, a combustor jacket, a turbine, and a discharge device. The oxidizer pump is configured and positioned to pressurize a liquid oxidizer exiting a coolant source. The fuel pump is configured and positioned to pressurize a liquid fuel exiting a fuel source. The coolant pump is configured and positioned to pressurize a liquid coolant exiting a coolant source. The combustor assembly comprises an injector configured and positioned to receive and combine the pressurized liquid oxidizer and the pressurized liquid fuel to form a reactant mixture, a combustion chamber configured and positioned to receive and combust the reactant mixture to produce propellant gases, and a primary nozzle configured and positioned to receive and exhaust the propellant gases. The combustor jacket surrounds and is configured to cool at least a portion of the combustion chamber and the primary nozzle of the combustor assembly using the pressurized liquid coolant exiting the coolant pump. The turbine is configured and positioned to receive and expand a gaseous coolant exiting the combustor jacket to power one or more of the coolant pump, the fuel pump, and the oxidizer pump. The discharge device is configured and positioned to receive, expand, and exhaust the expanded gaseous coolant exiting the turbine.

In yet further embodiments, a method of using a liquid-fueled rocket engine assembly comprises directing a first pressurized liquid material and a second pressurized liquid material into a combustor assembly comprising an injector, a combustion chamber, and a primary nozzle. A third pressurized liquid material is directed into a combustor jacket surrounding at least a portion of the combustor assembly to cool the at least a portion of the combustor assembly and form a gaseous material. The gaseous material is expanded within a turbine operatively associated with at least one pump used to form one or more of the first pressurized liquid material, the second pressurized liquid material, and the third pressurized liquid material to drive the turbine and power the at least one pump. From about 0 percent to about 100 percent of an expanded gaseous material exiting the turbine is exhausted.

### BRIEF DESCRIPTION OF THE DRAWINGS

FIG. 1 shows a simplified schematic representation of a liquid-fueled rocket engine assembly, according to an embodiment of the disclosure.

FIG. 2 shows a simplified schematic representation of a liquid-fueled rocket engine assembly, according to another embodiment of the disclosure.

### DETAILED DESCRIPTION

Liquid-fueled rocket engines assemblies are described, as are methods of using the liquid-fueled rocket engine assemblies. For example, in accordance with an embodiment of the disclosure, a liquid-fueled rocket engine assembly includes a combustor assembly, an oxidizer source, an oxidizer pump, a fuel source, a fuel pump, a combustor jacket, a turbine, a flow control device, a discharge device, a heat exchanger, and a mixer. The combustor assembly includes an injector, a combustion chamber, and a nozzle. The oxidizer pump is configured and positioned to pressurize a liquid oxidizer (e.g., liquid oxygen, liquid hydrogen peroxide, etc.) exiting the oxidizer source and to direct the pressurized liquid oxidizer into the combustor assembly. The combustor jacket surrounds the combustor assembly and is configured to cool the combustor assembly using a portion of a pressurized liquid fuel exiting the fuel pump. The turbine is configured and positioned to receive and expand a gaseous fuel exiting the combustor jacket to power one or more (e.g., each) of the fuel pump and the oxidizer pump. The flow control device comprises a first outlet and a second outlet, and is configured and positioned to direct an expanded gaseous fuel exiting the turbine through one or more of the first outlet and the second outlet. The flow control device may adjustably control amounts of the expanded gaseous fuel exiting the first outlet and the second outlet. The amounts of the expanded gaseous fuel exiting the first outlet and the second outlet may be selected at least partially based on properties (e.g., material composition, flow rate, temperature, pressure, etc.) of the expanded gaseous fuel and on desired operational parameters (e.g., desired turbine power output, desired combustion chamber pressure, etc.) of the liquid-fueled rocket engine assembly to maintain an expander cycle of the liquid-fueled rocket engine assembly. The discharge device is configured and positioned to receive, expand, and exhaust at least a portion of the expanded gaseous fuel (if any) exiting the first outlet of the flow control device. The heat exchanger is configured and positioned to heat another portion of the pressurized liquid fuel exiting the fuel pump with at least a portion of the expanded gaseous fuel (if any) exiting the second outlet of the flow control device and to direct a resulting heated, pressurized liquid fuel into the combustor assembly. The mixer is configured and positioned to combine a cooled fuel exiting the heat exchanger with a liquid fuel (e.g., liquid hydrogen; liquid ammonia; a low molecular weight liquid hydrocarbon, such as liquid methane; etc.) exiting the fuel source to form a mixed liquid fuel and to direct the mixed liquid fuel to the fuel pump. The liquid-fueled rocket engine assemblies and methods of the disclosure may reliably establish and maintain expander cycles for a wide variety of materials (e.g., fuels, oxidizers, coolants, etc.) and process parameters (e.g., flow rates, combustion chamber pressures, temperatures, etc.). The liquid-fueled rocket assemblies and methods of the disclosure may provide increased flexibility, increased efficiency, and/or reduced costs as compared to conventional liquid-fueled rocket engine assemblies and conventional methods of using liquid-fueled rocket engine assemblies.

The following description provides specific details, such as sizes, shapes, material compositions, and orientations in order to provide a thorough description of embodiments of the disclosure. However, a person of ordinary skill in the art would understand that the embodiments of the disclosure may be practiced without necessarily employing these specific details. Embodiments of the disclosure may be practiced in conjunction with conventional fabrication techniques employed in the industry. In addition, the description provided below does not foini a complete process flow for manufacturing a liquid-fueled rocket engine assembly. Only those process acts and structures necessary to understand the embodiments of the disclosure are described in detail below. Additional acts to form a complete liquid-fueled rocket engine assembly from the structures described herein may be performed by conventional fabrication processes.

Drawings presented herein are for illustrative purposes only, and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, spatially relative terms, such as “beneath,” “below,” “lower,” “bottom,” “above,” “over,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “over” or “above” or “on” or “on top of” other elements or features would then be oriented “below” or “beneath” or “under” or “on bottom of” the other elements or features. Thus, the term “over” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, “and/or” includes any and all combinations of one or more of the associated listed items.

As used herein, the terms “configured” and “configuration” refer to a size, shape, material composition, orientation, and arrangement of one or more of at least one structure and at least one apparatus facilitating operation of one or more of the structure and the apparatus in a predetermined way.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

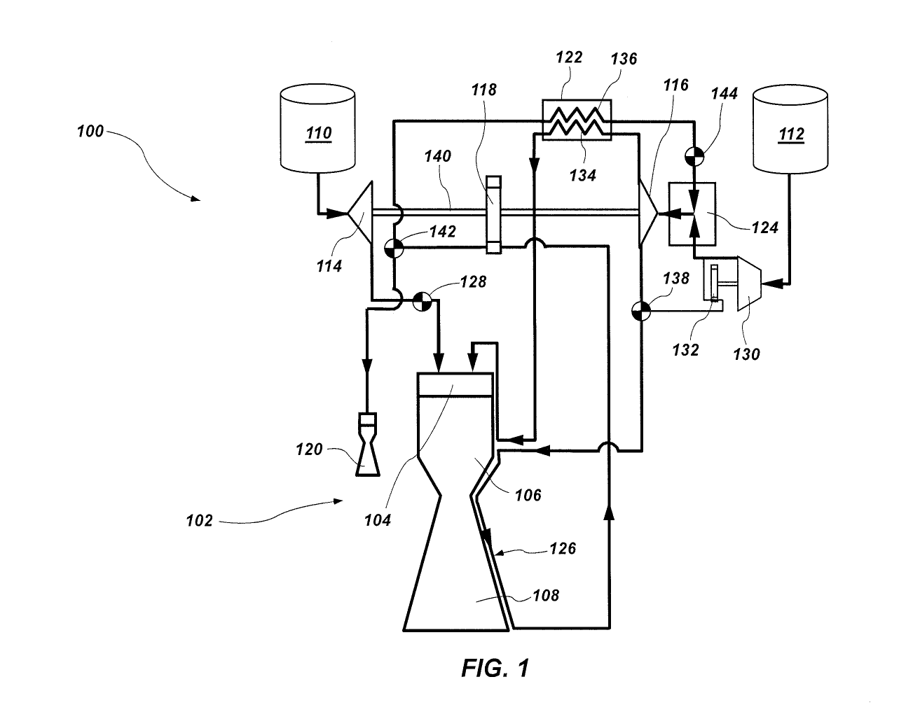

FIG. 1 is a simplified schematic view of a liquid-fueled rocket engine assembly 100, in accordance with an embodiment of the disclosure. As shown in FIG. 1, the liquid-fueled rocket engine assembly 100 includes a combustor assembly 102 including an injector 104, a combustion chamber 106, and a nozzle 108. The liquid-fueled rocket engine assembly 100 also includes at least one oxidizer source 110, at least one oxidizer pump 114 downstream of the oxidizer source 110 and upstream of the combustor assembly 102, at least one fuel source 112, at least one fuel pump 116 downstream of the fuel source 112, at least one turbine 118 operatively associated with (e.g., mechanically coupled to) the oxidizer pump 114 and the fuel pump 116, at least one flow control device 142 downstream of the turbine 118, at least one discharge device 120 downstream of the flow control device 142, at least one heat exchanger 122 downstream of each of the flow control device 142 and the fuel pump 116 and upstream of the combustor assembly 102, at least one mixer 124 downstream of each of the heat exchanger 122 and the fuel source 112 and upstream of the fuel pump 116, at least one combustor jacket 126 downstream of the mixer 124 and upstream of the turbine 118, and various conduits configured and positioned to direct one or more fluids between the various components of the liquid-fueled rocket engine assembly 100.

The oxidizer source 110 may comprise at least one vessel (e.g., at least one pressure vessel) configured and operated to at least temporarily hold (e.g., store, contain, etc.) a volume of liquid oxidizer, such as liquid oxygen, liquid hydrogen peroxide, etc. The oxidizer source 110 may be fluidly coupled to an inlet of the oxidizer pump 114, such that oxidizer exiting the oxidizer source 110 is directed (e.g., flowed, fed, delivered, etc.) into the oxidizer pump 114. In addition, at least one oxidizer boost pump may, optionally, be positioned between the oxidizer source 110 and the oxidizer pump 114. If present, the oxidizer boost pump may be operatively associated with at least one oxidizer boost turbine, and may be configured to pump liquid oxidizer from the oxidizer source 110 into the oxidizer pump 114.

The oxidizer pump 114 may comprise at least one device or apparatus configured and positioned to receive liquid oxidizer (e.g., liquid oxygen, liquid hydrogen peroxide, etc.) from the oxidizer source 110 and to increase the pressure of the liquid oxidizer. An outlet of the oxidizer pump 114 may be fluidly coupled to (e.g., in fluid communication with) an inlet of the injector 104 of the combustor assembly 102, such that pressurized liquid oxidizer exiting the oxidizer pump 114 is directed into the injector 104, as described in further detail below. Optionally, as shown in FIG. 1, an oxidizer control valve 128 may be positioned between the oxidizer pump 114 and the injector 104 of the combustor assembly 102, and may be configured to control an amount (e.g., mass flow) of liquid oxidizer directed into the injector 104.

The fuel source 112 may comprise at least one vessel (e.g., at least one pressure vessel) configured and operated to at least temporarily hold (e.g., store, contain, etc.) a volume of liquid fuel, such as liquid hydrogen, liquid ammonia, a low molecular weight liquid hydrocarbon (e.g., liquid methane), combinations thereof, etc. The fuel source 112 may be fluidly coupled to an inlet of the mixer 124, such that liquid fuel exiting the fuel source 112 is directed into the mixer 124. In addition, as shown in FIG. 1, at least one fuel boost pump 130 may, optionally, be positioned between the fuel source 112 and the mixer 124. If present, the fuel boost pump 130 may be operatively associated with at least one fuel boost turbine 132, and may be configured to pump liquid fuel from fuel source 112 into the mixer 124.

The mixer 124 may comprise at least one device or apparatus configured and positioned to receive each of liquid fuel (e.g., liquid hydrogen, liquid ammonia, liquid methane, etc.) from the fuel source 112 and additional (e.g., recirculated) fuel from the heat exchanger 122 and to produce a mixed liquid fuel that may be directed to the fuel pump 116. The liquid fuel received from the fuel source 112 may be relatively cold as compared to the additional fuel received from the heat exchanger 122. Accordingly, the mixer 124 may be configured to sufficiently mix the liquid fuel received from the fuel source 112 and the additional fuel received from the heat exchanger 122 to prevent the formation of gas pockets within the mixer 124 and also prevent cavitation within the fuel pump 116.

The fuel pump 116 may comprise at least one device or apparatus configured and positioned to receive liquid fuel (e.g., mixed liquid fuel) from the mixer 124 and to increase the pressure of the fuel. As shown in FIG. 1, the fuel pump 116 may include outlets fluidly coupled to (e.g., in fluid communication with) inlets of the combustor jacket 126 and the heat exchanger 122, such that pressurized liquid fuel exiting the fuel pump 116 is directed into one or more of the combustor jacket 126 and a first channel 134 of the heat exchanger 122, as described in further detail below. In addition, as shown in FIG. 1, in some embodiments wherein the liquid-fueled rocket engine assembly 100 includes a fuel boost pump 130 and an associated fuel boost turbine 132, a control valve 138 may, optionally, be positioned between the fuel pump 116 and each of the combustor jacket 126 and the fuel boost turbine 132. The control valve 138 may be configured to control (e.g., increase or decrease) amounts of the pressurized liquid fuel directed into the combustor jacket 126 and the fuel boost turbine 132.

The combustor jacket 126 may comprise at least one device or apparatus configured and positioned to receive pressurized liquid fuel from the fuel pump 116 and to transfer heat from components of the combustor assembly 102 to the pressurized liquid fuel. As shown in FIG. 1, the combustor jacket 126 may at least partially (e.g., substantially) surround the combustion chamber 106 of the combustor assembly 102 and the nozzle 108 of the combustor assembly 102. In addition, an outlet of the combustor jacket 126 may be fluidly coupled to (e.g., in fluid communication with) an inlet of the turbine 118. As heat is transferred from the combustor assembly 102 to the pressurized liquid fuel within the combustor jacket 126, the pressurized liquid fuel may transition from a liquid phase to a gaseous phase (e.g., a vapor phase), and then the heated, gaseous fuel may be directed to the turbine 118. The combustor jacket 126 may be configured to extract sufficient heat from the combustor assembly 102 to prevent overheating and damage to the components of the combustor assembly 102.

The turbine 118 may comprise at least one device or apparatus configured and positioned to drive the oxidizer pump 114 and the fuel pump 116. The turbine 118 may be configured and positioned to receive heated, gaseous fuel from the combustor jacket 126, and to convert thermal energy stored in the heated, gaseous fuel into kinetic energy to drive one or more (e.g., each) of the oxidizer pump 114 and the fuel pump 116. The turbine 118 may be mechanically coupled to one or more (e.g., each) of the oxidizer pump 114 and the fuel pump 116. For example, as shown in FIG. 1, the turbine 118, the oxidizer pump 114, and the fuel pump 116 may share a single (e.g., only one) shaft 140 that directly, rotationally couples the turbine 118, the oxidizer pump 114, and the fuel pump 116. In some embodiments, a transmission (e.g., a gear box) may be used to mechanically couple the turbine 118 to the shaft 140 and transfer power from the turbine 118 to the oxidizer pump 114 and/or the fuel pump 116. In further embodiments, the oxidizer pump 114 and the fuel pump 116 may be operatively associated with (e.g., mechanically coupled to) separate turbines. An outlet of the turbine 118 may be fluidly coupled to (e.g., in fluid communication with) an inlet of a flow control device 142 (e.g., three-way valve), such that a cooled, expanded gaseous fuel exiting the turbine 118 is directed into the flow control device 142.

The flow control device 142 may comprise at least one device or apparatus configured and positioned to receive the cooled, expanded gaseous fuel exiting the turbine 118, and to control amounts (e.g., mass flow) of the cooled, expanded gaseous fuel directed to each of the discharge device 120 and the heat exchanger 122. The flow control device 142 may include outlets fluidly coupled to (e.g., in fluid communication with) inlets of the discharge device 120 and the heat exchanger 122, as well as means of controlling fluid flow through each of the outlets, such that the cooled, expanded gaseous fuel received by the flow control device 142 is controllably directed into one or more of the discharge device 120 and a second channel 136 of the heat exchanger 122. By way of non-limiting example, the flow control device 142 may comprise a three-way valve. A ratio of an amount of the cooled, expanded gaseous fuel directed to the discharge device 120 to another amount of the cooled, expanded gaseous fuel directed to the heat exchanger 122 may be selected at least partially based on properties (e.g., material composition, flow rate, temperature, pressure, etc.) of the cooled, expanded gaseous fuel and on desired operational parameters (e.g., a desired power output of the turbine 118, a desired chamber pressure of the combustion chamber 106, etc.) and predetermined performance metrics of the liquid-fueled rocket engine assembly 100. The flow control device 142 may, for example, be configured and positioned to direct (e.g., divert) from about 0 percent to about 100 percent (e.g., from about 0 percent to about 50 percent, such as 0 percent, or from about 20 percent to about 50 percent; from about or from about 50 percent to about 100 percent, such as 100 percent, or from about 50 percent to about 80 percent) of the cooled, expanded gaseous fuel exiting the turbine 118 to the heat exchanger 122, and to direct a remainder of the cooled, expanded gaseous fuel exiting the turbine 118 to the discharge device 120.

The discharge device 120 may comprise at least one device or apparatus configured and positioned to receive, expand, and discharge (e.g., exhaust) at least a portion of the cooled, expanded gaseous fuel exiting the flow control device 142 (e.g., a portion of the cooled, expanded gaseous fuel not directed to the heat exchanger 122). As shown in FIG. 1, in some embodiments, the discharge device 120 comprises a secondary nozzle separate (e.g., discrete) from the combustor assembly 102. In additional embodiments, the discharge device 120 comprises a component of the combustor assembly 102 configured and operated to receive and discharge the cooled, expanded gaseous fuel. For example, the discharge device 120 may comprise a portion of the nozzle 108, such as a portion of the nozzle 108 configured and operated to facilitate supersonic flow therein. In such embodiments, the cooled, expanded gaseous fuel may be directed into the component (e.g., the nozzle 108) of the combustor assembly 102 without passing through and/or being acted upon (e.g., combusted) by one or more other components (e.g., the combustion chamber 106) of the combustor assembly 102. The ability to discharge at least a portion of the cooled, expanded gaseous fuel exiting the flow control device 142 may permit the liquid-fueled rocket engine assembly 100 to achieve desirable operational parameters (e.g., relatively higher turbine power outputs, relatively higher combustion chamber pressures, etc.) for a variety of different fuel types, oxidizer types, fuel flowrates, and/or oxidizer flowrates without performance losses and/or failures that may otherwise be associated with configuring (e.g., sizing) one or more components (e.g., heat exchangers, mixers, etc.) of the liquid-fueled rocket engine assembly 100 to accommodate (e.g., receive) all of the cooled, expanded gaseous fuel exiting the turbine 118.

The heat exchanger 122 may comprise at least one device or apparatus configured and positioned to receive a portion of the pressurized liquid fuel exiting the fuel pump 116 (e.g., a portion of the pressurized liquid fuel exiting the fuel pump 116 not directed to at least one of the combustor jacket 126 and the fuel boost turbine 132) and at least a portion of the cooled, expanded gaseous fuel exiting the flow control device 142 (e.g., a portion of the cooled, expanded gaseous fuel not directed to the discharge device 120), and to facilitate the transfer of heat from the cooled, expanded gaseous fuel from the flow control device 142 to the pressurized liquid fuel from the fuel pump 116. By way of non-limiting example, the heat exchanger 122 may be configured as one or more of a counter-flow heat exchanger, a shell and tube heat exchanger, a plate heat exchanger, and a plate fin heat exchanger. As shown in FIG. 1, the portion of the pressurized liquid fuel may be received into the first channel 134 of the heat exchanger 122, and the at least a portion of the cooled, expanded gaseous fuel may be received into the second channel 136 of the heat exchanger 122 fluidly separated (e.g., fluidly isolated) from the first channel 134. Within the second channel 136 of the heat exchanger 122, the cooled, expanded gaseous fuel received from the flow control device 142 may be further cooled to a temperature close to a phase-transition temperature thereof to form additional fuel, which may exit the second channel 136 of the heat exchanger 122 and be directed into the mixer 124 to be combined (e.g., mixed) with the liquid fuel from the fuel source 112 to form additional mixed liquid fuel. Optionally, another control valve 144 may be positioned between the heat exchanger 122 and the mixer 124, and may be configured to control an amount of the additional fuel directed into the mixer 124. Furthermore, within the first channel 134 of the heat exchanger 122, the portion of the pressurized liquid fuel from the fuel pump 116 may be heated to form a heated, pressurized liquid fuel, which may exit the first channel 134 of the heat exchanger 122 and be directed into the injector 104 of the combustor assembly 102.

The injector 104 of the combustor assembly 102 may comprise at least one device or apparatus configured and positioned to mix the heated, pressurized liquid fuel received from the heat exchanger 122 and the pressurized liquid oxidizer received from the oxidizer pump 114, and to deliver the resulting reactant mixture to the combustion chamber 106 of the combustor assembly 102, wherein the reactant mixture may be ignited and combusted to produce propellant gases. In turn, the nozzle 108 may be coupled to the combustion chamber 106 and may be configured to direct the produced propellant gases out of the combustor assembly 102 through an opening at an end of the nozzle 108 to generate thrust (e.g., sufficient thrust to propel a vehicle including the liquid-fueled rocket engine assembly 100).

During use and operation of the liquid-fueled rocket engine assembly 100, a liquid fuel (e.g., liquid hydrogen, liquid ammonia, liquid methane, etc.) may be directed from the fuel source 112 into the mixer 124. Within the mixer 124, the liquid fuel may, optionally, be combined with additional (e.g., recirculated) fuel received from the heat exchanger 122. The liquid fuel and/or resulting mixed liquid fuel may then exit the mixer 124 and may be delivered into the fuel pump 116. Thereafter, a resulting pressurized liquid fuel may be separated (e.g., split, divided, etc.) into a first portion (e.g., a first fuel substream) and a second portion (e.g., a second fuel substream). The first portion may be directed through the first channel 134 of the heat exchanger 122 and into the injector 104 of the combustor assembly 102 using pressure provided by the fuel pump 116. Within the injector 104, the first portion of the pressurized liquid fuel may be combined with pressurized liquid oxidizer delivered from the oxidizer source 110 using the oxidizer pump 114 to produce a reactant mixture. The reactant mixture may be directed into and combusted within the combustion chamber 106 of the combustor assembly 102 to generate propellant gases, which may then be exhausted from the nozzle 108 of the combustor assembly 102 to generate thrust. Concurrently, the second portion of the pressurized liquid fuel may be directed into the combustor jacket 126. Within the combustor jacket 126, the second portion of the pressurized liquid fuel may extract heat from the combustor assembly 102 to form a heated, gaseous fuel that may be directed into the turbine 118 to drive the turbine 118 and power one or more (e.g., each) of the oxidizer pump 114 and the fuel pump 116. Cooled, expanded gaseous fuel may then exit the turbine 118 and may be directed into the flow control device 142. Within the flow control device 142, the cooled, expanded gaseous fuel may, optionally, be divided into a first portion (e.g., a first cooled, expanded gaseous fuel substream) and a second portion (e.g., a second cooled, expanded gaseous fuel substream) at least partially depending on properties (e.g., material composition, flow rate, temperature, pressure, etc.) of the cooled, expanded gaseous fuel and on desired operational parameters (e.g., turbine power output, combustion chamber pressure, etc.) of the liquid-fueled rocket engine assembly 100, as described in further detail below. The first portion (if any) of the cooled, expanded gaseous fuel may be directed into the discharge device 120, wherein it may be expanded and exhausted. The second portion (if any) of the cooled, expanded gaseous fuel may be directed through the second channel 136 of the heat exchanger 122 and into the mixer 124 and may be combined with more fuel from the fuel source 112.

The relative amounts of the cooled, expanded gaseous fuel directed to the discharge device 120 and the heat exchanger 122 may be controlled (e.g., selected, maintained, adjusted, etc.) to ensure that the heat exchanger 122 and/or the mixer 124 is/are able to sufficiently decrease the temperature of and condense the cooled, expanded gaseous fuel to maintain an expander cycle of the liquid-fueled rocket engine assembly 100. For example, in some embodiments where it is desirable to operate the liquid-fueled rocket engine assembly 100 at a relatively higher combustion chamber pressure (e.g., a combustion chamber pressure greater than or equal to about 1200 psi, or a combustion chamber pressure greater than or equal to about 1600 psi), the flow control device 142 may be used to decrease an amount of the cooled, expanded gaseous fuel directed to the heat exchanger 122 (and, hence, increase an amount of the cooled, expanded gaseous fuel directed into the discharge device 120). Without decreasing the amount of the cooled, expanded gaseous fuel directed to the heat exchanger 122 (e.g., such as if all of the cooled, expanded gaseous fuel entering the flow control device 142 was directed to the heat exchanger 122), the liquid-fueled rocket engine assembly 100 may be unable to maintain the expander cycle at the material flow rates and associated pump power requirements needed to facilitate the relatively higher combustion chamber pressure or may require an undesirably large heat exchanger 122 (and/or mixer 124) to facilitate sufficient additional cooling of the cooled, expanded gaseous fuel. By way of non-limiting example, an amount of the cooled, expanded gaseous fuel directed to the heat exchanger 122 from the flow control device 142 may be within a range of from about 0 percent to about 50 percent of an amount of the cooled, expanded gaseous fuel entering into the flow control device 142. In some embodiments, an amount of the cooled, expanded gaseous fuel directed to the heat exchanger 122 from the flow control device 142 is within a range of from about 20 percent to about 50 percent of the amount of the cooled, expanded gaseous fuel entering into the flow control device 142. In further embodiments, an amount of the cooled, expanded gaseous fuel directed to the heat exchanger 122 from the flow control device 142 is about 0 percent of the amount of the cooled, expanded gaseous fuel entering into the flow control device 142.

In additional embodiments, such as in embodiments where it is desirable to operate the liquid-fueled rocket engine assembly 100 at a relatively lower combustion chamber pressure (e.g., a combustion chamber pressure less than about 1200 psi), the flow control device 142 may be used to increase the amount of the cooled, expanded gaseous fuel directed to the heat exchanger 122 (and, hence, decrease the amount of the cooled, expanded gaseous fuel directed into the discharge device 120) to increase the efficiency and performance (e.g., by reducing the amount of exhausted fuel and improving specific impulse) of the liquid-fueled rocket engine assembly 100. By way of non-limiting example, an amount of the cooled, expanded gaseous fuel directed to the heat exchanger 122 from the flow control device 142 may be within a range of from about 50 percent to about 100 percent of an amount of the cooled, expanded gaseous fuel entering into the flow control device 142. In some embodiments, an amount of the cooled, expanded gaseous fuel directed to the heat exchanger 122 from the flow control device 142 is within a range of from about 50 percent to about 80 percent of the amount of the cooled, expanded gaseous fuel entering into the flow control device 142. In further embodiments, an amount of the cooled, expanded gaseous fuel directed to the heat exchanger 122 from the flow control device 142 is about 100 percent of the amount of the cooled, expanded gaseous fuel entering into the flow control device 142.

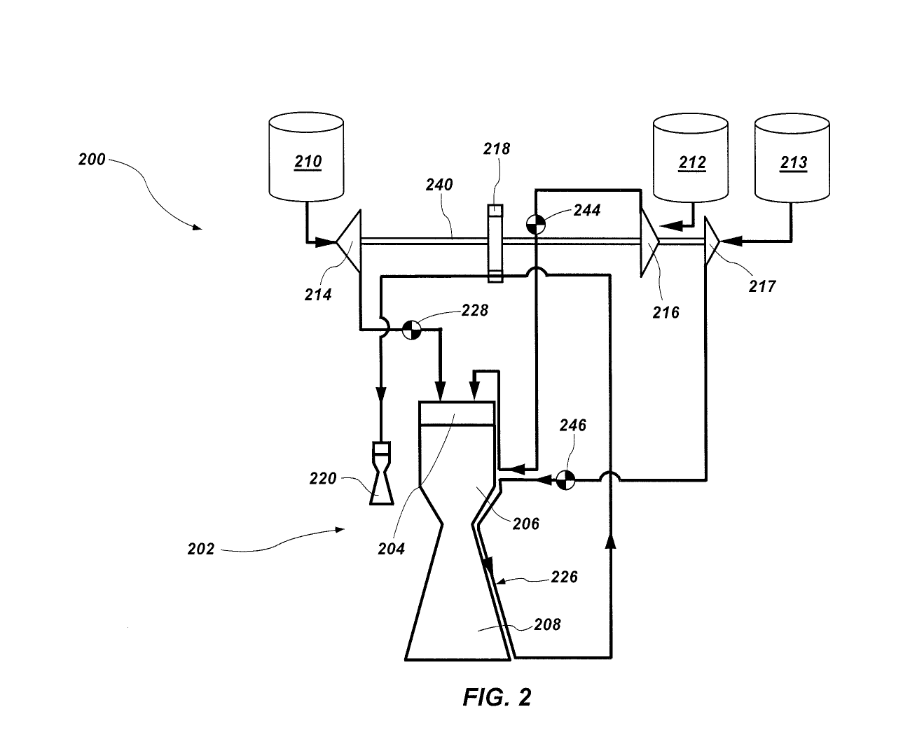

FIG. 2 is a simplified schematic view of a liquid-fueled rocket engine assembly 200 in accordance with an additional embodiment of the disclosure. As shown in FIG. 2, the liquid-fueled rocket engine assembly 200 includes a combustor assembly 202 including an injector 204, a combustion chamber 206, and a nozzle 208. The liquid-fueled rocket engine assembly 200 also includes at least one oxidizer source 210, at least one oxidizer pump 214 downstream of the oxidizer source 210 and upstream of the combustor assembly 202, at least one fuel source 212, at least one fuel pump 216 downstream of the fuel source 212 and upstream of the combustor assembly 202, at least one coolant source 213, at least one coolant pump 217 downstream of the coolant source 213, at least one turbine 218 operatively associated with (e.g., mechanically coupled to) the oxidizer pump 214, the fuel pump 216, and the coolant pump 217, at least one discharge device 220 downstream of the turbine 218, at least one combustor jacket 226 downstream of the coolant pump 217 and upstream of the turbine 218, and various conduits configured and positioned to direct one or more fluids between the various components of the liquid-fueled rocket engine assembly 200.

The oxidizer source 210 may comprise at least one vessel (e.g., pressure vessel) configured and operated to at least temporarily hold (e.g., store, contain, etc.) a volume of liquid oxidizer, such as liquid oxygen, liquid hydrogen peroxide, combinations thereof, etc. The oxidizer source 210 may be fluidly coupled to an inlet of the oxidizer pump 214, such that liquid oxidizer exiting the oxidizer source 210 is directed into the oxidizer pump 214. In addition, at least one oxidizer boost pump may, optionally, be positioned between the oxidizer source 210 and the oxidizer pump 214. If present, the oxidizer boost pump may be operatively associated with at least one oxidizer boost pump turbine, and may be configured to pump liquid oxidizer from the oxidizer source 210 into the oxidizer pump 214.

The oxidizer pump 214 may comprise at least one device or apparatus configured and positioned to receive liquid oxidizer (e.g., liquid oxygen, liquid hydrogen peroxide, combinations thereof, etc.) from the oxidizer source 210 and to increase the pressure of the liquid oxidizer. An outlet of the oxidizer pump 214 may be fluidly coupled to (e.g., in fluid communication with) an inlet of the injector 204 of the combustor assembly 202, such that pressurized liquid oxidizer exiting the oxidizer pump 214 is directed into the injector 204. Optionally, as shown in FIG. 2, a control valve 228 may be positioned between the oxidizer pump 214 and the injector 204 of the combustor assembly 202, and may be configured to control an amount (e.g., volume) of pressurized liquid oxidizer directed into the injector 204.

The fuel source 212 may comprise at least one vessel (e.g., at least one pressure vessel) configured and operated to at least temporarily hold (e.g., store, contain, etc.) a volume of liquid fuel, such as liquid hydrogen, liquid ammonia, a liquid hydrocarbon (e.g., liquid methane, liquid propane, liquid kerosene, refined propellant-1 (RP-1), etc.), etc. The fuel source 212 may be fluidly coupled to an inlet of the fuel pump 216, such that liquid fuel exiting the fuel source 212 is directed into the fuel pump 216. In addition, at least one fuel boost pump may, optionally, be positioned between the fuel source 212 and the fuel pump 216. If present, the fuel boost pump may be operatively associated with at least one fuel boost pump turbine, and may be configured to pump liquid fuel from fuel source 212 into the fuel pump 216.

The fuel pump 216 may comprise at least one device or apparatus configured and positioned to receive liquid fuel (e.g., liquid hydrogen, liquid ammonia, a liquid hydrocarbon, etc.) from the fuel source 212 and to increase the pressure of the liquid fuel. An outlet of the fuel pump 216 may be fluidly coupled to (e.g., in fluid communication with) an inlet of the injector 204 of the combustor assembly 202, such that pressurized liquid fuel exiting the fuel pump 216 is directed into the injector 204. Optionally, as shown in FIG. 2, another control valve 244 may be positioned between the fuel pump 216 and the injector 204 of the combustor assembly 202, and may be configured to control an amount (e.g., volume) of pressurized liquid fuel directed into the injector 204.

The injector 204 of the combustor assembly 202 may comprise at least one device or apparatus configured and positioned to mix the pressurized liquid fuel received from the fuel pump 216 and the pressurized liquid oxidizer received from the oxidizer pump 214, and to deliver the resulting reactant mixture to the combustion chamber 206 of the combustor assembly 202, wherein the reactant mixture may be ignited and combust to produce propellant gases. In turn, the nozzle 208 may be coupled to the combustion chamber 206 and may be configured to direct the produced propellant gases out of the combustor assembly 202 through an opening at an end of the nozzle 208 to generate thrust (e.g., sufficient thrust to propel a vehicle including the liquid-fueled rocket engine assembly 200).

The coolant source 213 may comprise at least one vessel (e.g., at least one pressure vessel) configured and operated to at least temporarily hold (e.g., store, contain, etc.) a volume of liquid coolant, such as liquid hydrogen, liquid ammonia, a low molecular weight liquid hydrocarbon (e.g., liquid methane), liquid water, combinations thereof, etc. The coolant source 213 may be fluidly coupled to an inlet of the coolant pump 217, such that liquid coolant exiting the coolant source 213 is directed into the coolant pump 217. In addition, at least one coolant boost pump may, optionally, be positioned between the coolant source 213 and the coolant pump 217. If present, the coolant boost pump may be operatively associated with at least one coolant boost turbine, and may be configured to pump liquid coolant from coolant source 213 into the coolant pump 217.

The coolant pump 217 may comprise at least one device or apparatus configured and positioned to receive liquid coolant (e.g., liquid hydrogen, liquid ammonia, liquid methane, liquid water, etc.) from the coolant source 213 and to increase the pressure of the liquid coolant. An outlet of the coolant pump 217 may be fluidly coupled to (e.g., in fluid communication with) an inlet of the combustor jacket 226, such that pressurized liquid coolant exiting the coolant pump 217 is directed into the combustor jacket 226. Optionally, an additional control valve 246 may be positioned between the coolant pump 217 and the combustor jacket 226, and may be configured to control an amount (e.g., volume) of pressurized liquid coolant directed into the combustor jacket 226.

The combustor jacket 226 may comprise at least one device or apparatus configured and positioned to receive pressurized liquid coolant from the coolant pump 217 and to transfer heat from components of the combustor assembly 202 to the pressurized liquid coolant. As shown in FIG. 2, the combustor jacket 226 may at least partially (e.g., substantially) surround the combustion chamber 206 of the combustor assembly 202 and the nozzle 208 of the combustor assembly 202. In addition, an outlet of the combustor jacket 226 may be fluidly coupled to (e.g., in fluid communication with) an inlet of the turbine 218. As heat is transferred from the combustor assembly 202 to the pressurized liquid coolant within the combustor jacket 226, the pressurized liquid coolant may transition from a liquid phase to a gaseous phase (e.g., a vapor phase), and then the heated, gaseous coolant may be directed into the turbine 218. The combustor jacket 226 may be configured to extract sufficient heat from the combustor assembly 202 to prevent overheating and damage to the components of the combustor assembly 202.

The turbine 218 may comprise at least one device or apparatus configured and positioned to drive the oxidizer pump 214, the fuel pump 216, and the coolant pump 217. The turbine 218 may be configured and positioned to receive heated, gaseous coolant from the combustor jacket 226, and to convert thermal energy stored in the heated, gaseous coolant into rotational movement of one or more (e.g., each) of the oxidizer pump 214, the fuel pump 216, and the coolant pump 217. The turbine 218 may be mechanically coupled to one or more (e.g., each) of the oxidizer pump 214, the fuel pump 216, and the coolant pump 217. For example, as shown in FIG. 2, the turbine 218, the oxidizer pump 214, the fuel pump 216, and the coolant pump 217 may share a single (e.g., only one) shaft 240 that directly, rotationally couples the turbine 218, the oxidizer pump 214, the fuel pump 216, and the coolant pump 217. In some embodiments, a transmission (e.g., a gear box) may be used to mechanically couple the turbine 218 to the shaft 240 and transfer power from the turbine 218 to the oxidizer pump 214, the fuel pump 216, and/or the coolant pump 217. In further embodiments, two or more of the oxidizer pump 214, the fuel pump 216, and the coolant pump 217 may be operatively associated with (e.g., mechanically coupled to) separate turbines. An outlet of the turbine 218 may be fluidly coupled to (e.g., in fluid communication with) an inlet of the discharge device 220, such that cooled, expanded gaseous coolant exiting the turbine 218 is directed into the discharge device 220.

The discharge device 220 may comprise at least one device or apparatus configured and positioned to receive, expand, and discharge (e.g., exhaust) the cooled, expanded gaseous coolant exiting the turbine 218. As shown in FIG. 2, in some embodiments, the discharge device 220 comprises a secondary nozzle separate (e.g., discrete) from the combustor assembly 202. In additional embodiments, the discharge device 220 comprises a component of the combustor assembly 202 configured and operated to receive and discharge the cooled, expanded gaseous fuel. For example, the discharge device 220 may comprise a portion of the nozzle 208, such as a portion of the nozzle 208 configured and operated to facilitate supersonic flow therein. In such embodiments, the cooled, expanded gaseous fuel may be directed into the component (e.g., the nozzle 208) of the combustor assembly 202 without passing through and/or being acted upon (e.g., combusted) by one or more other components (e.g., the combustion chamber 206) of the combustor assembly 202. The ability to exhaust the cooled, expanded gaseous coolant exiting the turbine 218 while combusting the pressurized liquid fuel directed into the combustor assembly 202 may permit the liquid-fueled rocket engine assembly 200 to achieve desirable operational parameters (e.g., relatively higher turbine power outputs, relatively elevated combustion chamber pressures, etc.) for a variety of different fuel types, coolant types, oxidizer types, fuel flowrates, coolant flowrates, and/or oxidizer flowrates without performance losses and/or failures that may otherwise be associated with configuring the liquid-fueled rocket engine assembly 200 to recirculate the cooled, expanded gaseous coolant.

During use and operation of the liquid-fueled rocket engine assembly 200, a liquid fuel (e.g., liquid hydrogen; liquid ammonia; a liquid hydrocarbon, such as liquid methane, liquid propane, liquid kerosene, etc.; combinations thereof; etc.) may be directed from the fuel source 212 and into the fuel pump 216. Pressurized liquid fuel may then exit the fuel pump 216 and may be directed into the injector 204 of the combustor assembly 202. Within the injector 204, the pressurized liquid fuel may be combined with pressurized liquid oxidizer (e.g., pressurized liquid oxygen, pressurized liquid hydrogen peroxide, combinations thereof, etc.) delivered from the oxidizer source 210 using the oxidizer pump 214 to form a reactant mixture. The reactant mixture may then be directed into and combusted within the combustion chamber 206 of the combustor assembly 202 to generate propellant gases, which may then be exhausted from the nozzle 208 of the combustor assembly 202 to generate thrust. Concurrently, a liquid coolant (e.g., liquid hydrogen, liquid ammonia, liquid methane, liquid water, etc.) may be directed from the coolant source 213 and into the coolant pump 217. Pressurized liquid coolant may then exit the coolant pump 217 and may be directed into the combustor jacket 226. Within the combustor jacket 226, the pressurized liquid coolant may extract heat from the combustor assembly 202 to form a heated, gaseous coolant. The heated, gaseous coolant may then be directed into the turbine 218 to drive the turbine 218 and power the oxidizer pump 214, the fuel pump 216, and the coolant pump 217. Cooled, expanded gaseous coolant may then exit the turbine 218 and may be directed into the discharge device 220, where it may be expanded and exhausted.

Employing a liquid coolant (e.g., the liquid coolant from the coolant source 213) fluidly isolated from a liquid fuel (e.g., the liquid fuel from the fuel source 212) to facilitate and maintain an expander cycle (e.g., an open expander cycle) of the liquid-fueled rocket engine assembly 200 may reduce the complexity of the liquid-fueled rocket engine assembly 200 and may increase the number of liquid fuels that may be employed by the liquid-fueled rocket engine assembly 200 (e.g., by the combustor assembly 202 of the liquid-fueled rocket engine assembly 200 to generate thrust) as compared to conventional expander-cycle liquid-fueled rocket engine assemblies. For example, employing a separate liquid coolant to maintain an open expander cycle of the liquid-fueled rocket engine assembly 200 may eliminate the need for additional equipment (e.g., heat exchangers, mixers, etc.) that may otherwise be needed to maintain a closed expander cycle, and/or may permit the use of liquid fuels (e.g., higher molecular weight liquid fuels and/or lower specific heat liquid fuels, such as liquid propane, liquid kerosene, etc.) that may be unsuitable to maintain an expander cycle.

The liquid-fueled rocket engine assemblies (e.g., the liquid-fueled rocket engine assemblies 100, 200) and methods of the disclosure may provide improved performance (e.g., improved specific impulse), increased efficiency, increased reliability, reduced costs (e.g., material costs, equipment costs, etc.), reduced weight, increased simplicity, and/or increased safety as compared to many conventional liquid-fueled rocket engine assemblies and associated conventional methods.

While the disclosure is susceptible to various modifications and alternative forms, specific embodiments have been shown by way of example in the drawings and have been described in detail herein. However, the disclosure is not limited to the particular forms disclosed. Rather, the disclosure is to cover all modifications, equivalents, and alternatives falling within the scope of the disclosure as defined by the following appended claims and their legal equivalents.

What is claimed is:

1. A liquid-fueled rocket engine assembly, comprising:
a combustor assembly comprising an injector, a combustion chamber, and a nozzle;
a combustor jacket at least partially surrounding and configured to cool the combustion chamber and the nozzle of the combustor assembly using a portion of a pressurized liquid fuel exiting a fuel pump;
a turbine configured and positioned to receive and expand a gaseous fuel exiting the combustor jacket to power one or more of the fuel pump and an oxidizer pump;
a flow control device comprising a first outlet and a second outlet, the flow control device configured and positioned to selectively direct an expanded gaseous fuel exiting the turbine through one or more of the first outlet and the second outlet;
a discharge device configured and positioned to receive, expand, and exhaust at least a portion of the expanded gaseous fuel exiting the first outlet of the flow control device;
a heat exchanger configured and positioned to cool at least a portion of the expanded gaseous fuel exiting the second outlet of the flow control device with another portion of the pressurized liquid fuel exiting the fuel pump and to direct a resulting heated, pressurized liquid fuel into the combustor assembly; and
a mixer configured and positioned to combine a cooled fuel exiting the heat exchanger with a liquid fuel exiting a fuel source to form a mixed liquid fuel and to direct the mixed liquid fuel to the fuel pump.

2. The liquid-fueled rocket engine assembly of claim 1, wherein the flow control device is configured and positioned to divide the expanded gaseous fuel exiting the turbine into at least two different portions.

3. The liquid-fueled rocket engine assembly of claim 1, wherein the flow control device comprises a three-way valve.

4. The liquid-fueled rocket engine assembly of claim 1, wherein the heat exchanger comprises:
a first channel configured and positioned to receive the pressurized liquid fuel exiting the fuel pump; and
a second channel configured and positioned to receive the at least a portion of the expanded gaseous fuel exiting the second outlet of the flow control device.

5. The liquid-fueled rocket engine assembly of claim 1, wherein the mixer comprises:
a first inlet configured and positioned to receive the liquid fuel from the fuel source;
a second inlet configured and positioned to receive the cooled fuel exiting the heat exchanger; and
an outlet configured and positioned to direct the mixed liquid to the fuel pump.

6. A liquid-fueled rocket engine assembly, comprising:
an oxidizer pump configured and positioned to pressurize a liquid oxidizer exiting a coolant source;
a fuel pump configured and positioned to pressurize a liquid fuel exiting a fuel source;
a coolant pump configured and positioned to pressurize a liquid coolant exiting a coolant source;
a combustor assembly comprising:
an injector configured and positioned to receive and combine the pressurized liquid oxidizer and the pressurized liquid fuel to form a reactant mixture;
a combustion chamber configured and positioned to receive and combust the reactant mixture to produce propellant gases; and
a nozzle configured and positioned to receive and exhaust the propellant gases;
a combustor jacket surrounding and configured to cool at least a portion of the combustion chamber and the nozzle of the combustor assembly using the pressurized liquid coolant exiting the coolant pump;
a turbine configured and positioned to receive and expand a gaseous coolant exiting the combustor jacket to power one or more of the coolant pump, the fuel pump, and the oxidizer pump; and
a discharge device configured and positioned to receive, expand, and exhaust the expanded gaseous coolant exiting the turbine.

7. The liquid-fueled rocket engine assembly of claim 6, wherein the discharge device is configured and positioned to receive, expand, and exhaust substantially all of the expanded gaseous coolant exiting the turbine.

8. The liquid-fueled rocket engine assembly of claim 6, wherein the turbine is mechanically coupled to each of the coolant pump, the fuel pump, and the oxidizer pump.

9. The liquid-fueled rocket engine assembly of claim 6, wherein the turbine is mechanically coupled to each of the coolant pump, the fuel pump, and the oxidizer pump through a single shaft directly, rotationally coupled to the turbine, the oxidizer pump, the fuel pump, and the coolant pump.

10. The liquid-fueled rocket engine assembly of claim 6, further comprising:
a control valve downstream of the oxidizer pump and upstream of the combustor assembly; and
another control valve downstream of the fuel pump and upstream of the combustor assembly.

11. The liquid-fueled rocket engine assembly of claim 6, further comprising a control valve downstream of the coolant pump and upstream of the combustor jacket.

12. A method of using a liquid-fueled rocket engine assembly, comprising:
directing a first pressurized liquid material and a second pressurized liquid material into a combustor assembly comprising an injector, a combustion chamber, and a primary nozzle;
directing a third pressurized liquid material into a combustor jacket surrounding at least a portion of the combustor assembly to cool the at least a portion of the combustor assembly and form a gaseous material;
expanding the gaseous material within a turbine operatively associated with at least one pump used to form one or more of the first pressurized liquid material, the second pressurized liquid material, and the third pressurized liquid material to drive the turbine and power the at least one pump; and
exhausting from about 0 percent to about 100 percent of an expanded gaseous material exiting the turbine.

13. The method of claim 12, wherein exhausting from about 0 percent to about 100 percent of an expanded gaseous material exiting the turbine comprises:
dividing the expanded gaseous material exiting the turbine within a flow control device to form a first portion of the expanded gaseous material and a second portion of the expanded gaseous material;
exhausting the first portion of the expanded gaseous material;
directing the second portion of the expanded gaseous material into a heat exchanger to cool the second portion of the expanded gaseous material with the first pressurized liquid material prior to directing the first pressurized liquid material into the combustor assembly;
combining a cooled material exiting the heat exchanger with a liquid material to form a mixed liquid material; and
pressurizing and splitting the mixed liquid material to form the first pressurized liquid material and the third pressurized liquid material.

14. The method of claim 13, wherein dividing the expanded gaseous material exiting the turbine within a flow control device comprises forming the second portion of the expanded gaseous material to comprise between about 0 percent and about 50 percent of the expanded gaseous material.

15. The method of claim 14, wherein forming the second portion of the expanded gaseous material to comprise between about 0 percent and about 50 percent of the expanded gaseous material comprises forming the second portion of the expanded gaseous material to comprise from about 20 percent to about 50 percent of the expanded gaseous material.

16. The method of claim 13, wherein dividing the expanded gaseous material exiting the turbine within a flow control device comprises forming the second portion of the expanded gaseous material to comprise between about 50 percent and about 100 percent of the expanded gaseous stream.

17. The method of claim 16, wherein forming the second portion of the expanded gaseous material to comprise between about 50 percent and about 100 percent of the expanded gaseous fuel comprises forming the second portion of the expanded gaseous material to comprise from about 50 percent to about 80 percent of the expanded gaseous material.

18. The method of claim 12, wherein:
directing a first pressurized liquid material and a second pressurized liquid material into a combustor assembly comprises directing a pressurized liquid fuel and a pressurized liquid oxidizer into the combustor assembly; and
directing a third pressurized liquid material into a combustor jacket surrounding at least a portion the combustor assembly comprises directing a pressurized liquid coolant into the combustor jacket.

19. The method of claim 18, further comprising:
directing a liquid fuel into a fuel pump from a fuel source to form the pressurized liquid fuel, the liquid fuel selected from the group consisting of liquid hydrogen, liquid ammonia, and a liquid hydrocarbon;
directing a liquid oxidizer into an oxidizer pump from an oxidizer source to form the pressurized liquid oxidizer, the liquid oxidizer selected from the group consisting of liquid oxygen and liquid hydrogen peroxide; and
directing a liquid coolant into a coolant pump from a coolant source to form the pressurized liquid coolant, the liquid coolant selected from the group consisting of liquid hydrogen, liquid ammonia, liquid methane, and liquid water.
